(19) United States
(12) Patent Application Publication
(10) Pub. No.: US 2015/0098873 A1
(43) Pub. Date: Apr. 9, 2015

(54) TEST CASSETTE

(71) Applicant: HUI-CHI KU, Kaohsiung City (TW)

(72) Inventor: HUI-CHI KU, Kaohsiung City (TW)

(21) Appl. No.: 14/246,887

(22) Filed: Apr. 7, 2014

(30) Foreign Application Priority Data
Oct. 8, 2013 (TW) 102218797

(51) Int. Cl. G01N 35/00; B01L 3/00

(52) U.S. Cl. CPC G01N 35/00732; G01N 35/00029; B01L 3/5023; G01N 2035/00752; G01N 2035/00851; G01N 2035/00108; B01L 2300/021
USPC 422/403; 422/554

(57) ABSTRACT

A test cassette applicable to an optical reading device capable of reading identification codes includes a test sheet with a supporting layer and a reactive reagent layer; a case for retaining the test sheet; and an identification code situated on a surface of the case for recording a test item and a test standard value of the test cassette.

### CROSS-REFERENCE TO RELATED APPLICATION

This application claims the benefit of Taiwan Patent Application No. 102218797, filed on Oct. 8, 2013, which is hereby incorporated by reference for all purposes as if fully set forth herein.

### BACKGROUND

1. Field of the Invention

The present invention relates to a test cassette and more particularly pertains to a test device in that an identification code is used for marking a test item thereof.

2. Related Art

Most of the rapid test cassettes on the current market are designed qualitatively and the interpretation manner is mainly from visual observation for a result. Such test manner is general, increases lots of personal errors of interpretation and is apt to cause confusion in test items, leading to a rough and precision insufficiency test way and therefore may consume multiple test cassettes and time to determine a test result, which is indeed an inefficient test device.

Other than that, generally after a test result is obtained from a test cassette, it is required for users to classify and record the test result on their own, and upon encountering heavy load of tests to be processed, much time will be taken in classification and results recording.

Owing to that currently portable 3C products and portable interpretation apparatuses are manufactured more sophisticatedly, the combination of portable 3C products and interpretation apparatuses with rapid test cassettes for a quantitative and rapid test result has become a main trend on today's rapid tests market.

### SUMMARY

To achieve the forgoing purpose, the present invention supplies a test cassette, applicable to an optical reading device capable of reading identification codes, the test cassette including a test sheet having a supporting layer and a reactive reagent layer; a case for retaining the test sheet; and an identification code situated on a surface of the case for recording a test item and a test standard value of the test cassette.

The present invention not only interprets data by the conventional visual observation but further adds an identification code for processing tests via an electronic reader device, facilitating a more precise test result, reducing the misjudgment caused by visual observation applied in test cassettes interpretation. Furthermore, the test result obtained from an electronic reader device may be digitalized straightaway and utilized in many ways, such as saving, transmitting and for comparison among test results, and thereby testing work may be carried out more efficiently and maintained.

Apart from the above, the test cassette of the present invention exploits electronic reader devices in testing, therefore decreasing time in interpretation learning for users and becoming easy in use for ordinary users. Moreover, when there are mass tests to be processed, they can be completed quickly and the confusion among test cassettes for different test items may be avoided.

In view of the foregoing characteristics, test efficiency with precision, quickness and easiness may be achieved.

### BRIEF DESCRIPTION OF THE DRAWINGS

FIG. 1 is a diagram of a test cassette according to the present invention.

FIG. 2 is a diagram of a reactive reagent layer of a test cassette according to the present invention.

### DETAILED DESCRIPTION

The present invention is described in embodiments with reference to the annexed drawings.

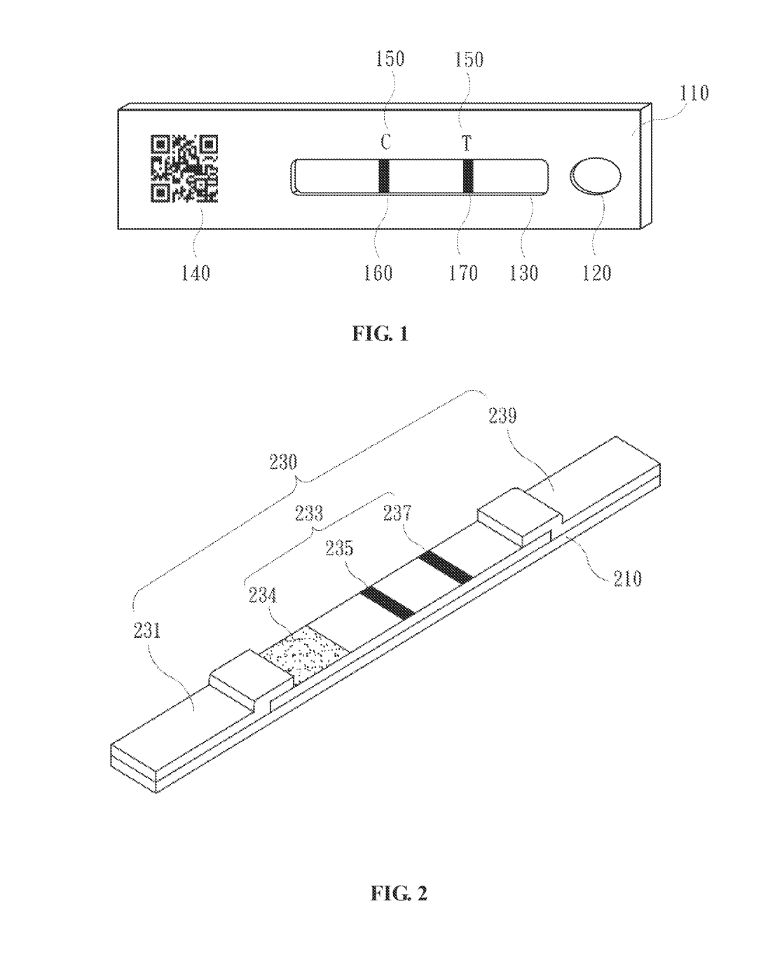

Please refer to FIG. 1, a diagram of a test cassette of the present invention, which includes a case 110, a specimen collection region 120, a test region 130, an identification code 140, a marking region 150, a control line 160 and a test line 170.

In the test cassette, the specimen collection region 120 and the test region 130 are connected on an identical surface, enabling liquid collected in the specimen collection region 120 to penetrate through the test region 130, and the case 110, used for fixing the surface, has two windows for exposures of the specimen collection region 120 and the test region 130 respectively.

The identification code 140 may be types of readable barcodes such as a one-dimensional bar code or a two-dimensional barcode, like a QR Code (Quick Response Code, a type of one-dimensional bar codes), which is situated on a surface of the case 110 and records a test item and a test standard value of the test cassette, wherein the test standard value may be a data, a data scope or a data database and so forth. The material of the case 110 may be a non-absorbent substrate, like a plastic and so forth to prevent influence on performing testing work.

The specimen collection region 120 is used for containing a specimen in certain required amount to be tested, and material of the specimen collection region 120 and the test region 130 may be an absorbent substrate for absorbing specimen in liquid.

The test region 130 includes the control line 160 and the test line 170, wherein the control line 160 is used for presenting whether the test is valid, for example, after a specimen is dropped into the specimen collection region 120, no color appearance in the control line 160 shall refer to an invalid test and on the contrary, after a specimen is dropped into the specimen collection region 120, one color presence in control line 160 shall indicate a valid test. The test line 170 is used for displaying a test result. In an example that the test line 170 is preset in blank, after a specimen is dropped into the specimen collection region 120, a color presence in both the control line 160 and the test line 170 indicates a positive test result and on the contrary, after a specimen is dropped into the specimen collection region 120, non-presence in any color in the test line 170 indicates a negative test result.

The identification code 140 is used for marking a test item and a test standard value of a test cassette and then an optical device capable of reading identification codes is used for performing reading and analyzing. For example, the optical device capable of reading identification codes may be a mobile phone with camera functions and thereby the mobile phone shoots the identification code and reads the test item marked by the identification code as a beta agonists (commonly known as ractopamine) and the test standard value as 0 ppb˜1 ppb (parts per billion).

The marking region 150 labels testing purposes of different lines and may vary in quantity according to the actual demands for interpretation of the test cassette. For example, the control line 160 is labeled as C, used for indicating whether a test is valid, and the test line 170 is labeled as T, used for displaying the test result.

FIG. 2 is a diagram of a reactive reagent layer 230 formed with at least the specimen collection region 120 and the test region 130 of FIG. 1, the reactive reagent layer 230 including a supporting layer 210, a specimen intake region 231, a reacting region 233, a gold conjugation region 234, a test line 235, a control line 237 and a liquid absorption region 239.

The reactive reagent layer 230 of FIG. 2 may be a long strip sheet in width of three millimeters, for which the dose of a specimen may be reduced to be 30-60 uL (approximately 1˜2 drops of specimen) and thereby quick completion of tests may be achieved.

The supporting layer 210 is a non-absorbent sheet bar and used as a base board for the specimen intake region 231, the reacting region 233 and the liquid absorption region 239. The specimen intake region 231 is an absorbent cladding fiber layers, such as a pharmaceutically treated glass fiber. The reacting region 233 may be formed with plural layers of a porous carrier substrate capable of providing capillary phenomenon and absorbing liquid, the upper surface of the reacting region 233 further comprising a layer of water-proof thin membrane, like a nitrocellulose membrane, to prevent specimen from accidentally dropping into the reacting region 233 and therefore to influence a test result. The liquid absorption region 239 is an absorbent cladding fiber layers, such as an absorbent paper.

In other words, hydrophilic substrate reagent passive component used in the specimen intake region 231, the reacting region 233 and the gold conjugation region 234 situated in the reacting region 233 can reduce the dose of a specimen and speed up the response time between the specimen and the reagent.

In the gold conjugation region 234 of the reacting region 233, a Colloidal gold is used for promoting color presence in response so as to increase sensitivity of tests.

The lower surface of the specimen intake region 231 and the upper surface of the reacting region 233 are partially overlapped, and the lower surface of the liquid absorption region 239 and the upper surface of the reacting region 233 are partially overlapped, so that the specimen dropped into the specimen intake region 231 flows into the reacting region 233 and the liquid absorption region 239 in the form of penetration, the specimen is combined with coloring agent contained in the reacting region 233 and test result is displayed in the test line 235 and the control line 237, and finally the specimen leftover is absorbed in the absorption region 239 thereby to prevent influence on performing testing work.

The test line 235 and the control line 237 may use a color respectively for marking the test result and the presence in color relates to the item in testing, for example, pregnancy test reagent uses a human chorionic gonadotropin (hCG) in combination with gold nanoparticles of a test line to present a color of ruby red.

The present invention is described illustratively in the foregoing embodiments, and it's not desired to limit the scope of the invention. Accordingly, it should be noted that for those of ordinary skill in the art, without departing from the spirit and scope, of the present invention, all suitable modifications and equivalents may be resorted to, falling within the scope of the invention.

What is claimed is:

1. A test cassette, applicable to an optical device capable of reading an identification code, including:
a test sheet having a supporting layer and a reactive reagent layer;
a case for retaining the test sheet; and
an identification code, situated on a surface of the case, used for recording a test item and a test standard value of the test cassette.

2. The test cassette of claim 1, wherein the identification code is a QR code (Quick Response Code).

3. The test cassette of claim 1, wherein the supporting layer is a non-absorbent sheet bar.

4. The test cassette of claim 3, wherein the non-absorbent sheet bar is a hard film strip or a non-absorbent hard paper sheet.

5. The test cassette of claim 1, wherein the reactive reagent layer further includes a specimen collection region, a test region and a liquid absorption region.

6. The test cassette of claim 1, wherein the case has two windows respectively exposing the specimen collection region and the test region.

7. The test cassette of claim 5, wherein the specimen collection region and the liquid absorption region are an absorbent fiber layer.

8. The test cassette of claim 5, wherein the test region is formed with plural layers of a substrate, capable of providing capillary phenomena and absorbing liquid, and the surface thereof is further covered with a water proof layer.

9. The test cassette of claim 5, wherein the test region thither includes a gold conjugation region, connected to the specimen collection region, and the gold conjugation region is formed with a substrate containing a Colloidal gold.

10. The test cassette of claim 5, wherein the test region further includes a control line containing a coloring agent to indicate whether a test result of the test sheet is valid, and a test line containing a reactant needed for the test item and joined with a specimen for testing.
